(19) United States
(12) Patent Application Publication
(10) Pub. No.: US 2026/0031729 A1
(43) Pub. Date: Jan. 29, 2026

(54) METHOD AND DEVICE FOR RELIABLE DC-DC CONVERTING CIRCUITS

(71) Applicant: ANH VIET TRUONG, HO CHI MINH (VN)

(72) Inventor: ANH VIET TRUONG, HO CHI MINH (VN)

(73) Assignee: HCMC University of Technology and Education, HO CHI MINH (VN)

(21) Appl. No.: 19/283,084

(22) Filed: Jul. 28, 2025

(30) Foreign Application Priority Data
Jul. 26, 2024 (VN) 1-2024-05573

(51) Int. Cl. H02M 3/158

(52) U.S. Cl. CPC H02M 3/1584

(57) ABSTRACT

The invention discloses a DC-DC voltage converter, which includes: i) a plurality of DC voltage converter circuits connected in series and in parallel, wherein each DC voltage converter circuit includes an inductor, a control switch, a diode, and a capacitor; and a plurality of control diodes arranged in parallel with the capacitor in the DC voltage converter circuit, wherein the number of diodes ND=2N−1 where N is the number of DC voltage converter circuits and N is a positive integer; and ii) a control circuit coupled to the control switch to operate the voltage converter when one or more control switches in the DC voltage converter circuit fail; and adjusting the conversion factor (boost factor) to always be a constant k.

### CLAIM OF PRIORITY

This application claims priorities under 35 U.S.C. § 119 (a)-(d) of Applications No. 1-2024-05573 entitled “B [symbol] bi [symbol] n [symbol] i [symbol] i [symbol] n áp m [symbol] t chi [symbol] u DC-DC”, filed on Jul. 26, 2024; in the Republic Socialist of Vietnam. These patent applications identified above are incorporated herein by reference in its entirety.

### FIELD OF THE INVENTION

The present invention relates generally to voltage converters. More specifically, the present invention relates to a step-up DC-DC converter.

### BACKGROUND ART

A DC-DC step-up converter is a DC power converter that increases voltage while decreases current from an unregulated input power supply to an output load. The circuit operates on the principle of storing energy in the form of a magnetic field in an inductor and an electric field in a capacitor. The stored energy is held or released by a switching elements such as MOSFETs and diodes. The basic and well-known configuration of the converter circuit includes four electronic components: a coil, a MOSFET switch (control), a diode and a capacitor.

Nowadays, semiconductor technology also finds its use in renewable energy sources. Therefore, DC-DC voltage converters are in great demands because of their important role in various applications including hybrid energy systems, electric vehicles, hybrid electric and gasoline/oil fuel vehicles, aerospace, satellite systems and portable electronic devices.

Y. Koç et al. have summarized the studies and uses of DC/DC converters in modern renewable energy systems [1]. F. A. Abbas et al. also mentioned, compared and analyzed among non-isolated high-order DC/DC converters for battery applications [2]. H. Tarzamni et al. also synthesized and compared the applicability of non-isolated high step-up DC-DC converters [3].

Prior-arts show that the current type non-isolated high-order DC/DC converters have quite complex configurations. They increase the complexity of the printed circuit layout. As such, the control of the duty cycle D for the control switches becomes complicated. This requires high programming ability and compatibility to meet the configuration of the microcontroller. In addition, the non-isolated high-order DC/DC converters use low switching frequency (25 kHz) to control the switches. Low frequency requires large inductor size. Large electrical components reduce the compactness and convenience of the DC-DC circuits. This also contributes to increased electrical losses. In addition, when one of the control switches fails, the prior-art non-isolated high-order DC/DC converters may fail.

Anh Viet Truong and colleagues came up with a DC booster circuit consisting of many cascaded booster circuits. In the cascaded booster circuits, the boost ratio is B=N/(1−D), where N is the number of booster circuit stages, D is the control pulse (Duty Cycle) [4]. However, in this configuration, the power supply reliability as well as response capability in case of stage failure are not guaranteed. Consequently, the circuit may not operate at a very low transformer ratio when either the capacitor or control switch fails.

Thus, there is a need for a DC-DC converters that achieve both reliability and efficiency.

There is a need for DC-DC converters that achieve high conversion ratio and control range.

There is a need for a DC-DC converters that have minimal losses.

There is a need for a DC-DC converters that can remain operable when one or more control switches fail.

Yet there is a need for a DC-DC converter that can always adjust to a constant boost factor K.

The method and the circuits of the present invention meets the above needs and solve the above-described problems.

### SUMMARY OF THE INVENTION

Accordingly, an object of the present invention is to provide a DC-DC converter that improves the conversion ratio and control range, improves efficiency, reduces losses, and the DC converter remains operational when one or more control switches fail.

Another object of the present invention is to provide Another object of the present invention is to provide a DC-DC converter that includes: a plurality of DC voltage converter circuits connected in series and in parallel in which each DC voltage converter circuit comprises an inductor, a control switch, a diode, and a capacitor; and a plurality of control diodes arranged in parallel with the capacitor in the DC voltage converter circuit; and a control circuit is linked to the control switch to operate the voltage converter so that when one or more control switches in the DC voltage converter circuit fail and that the conversion factor (boost factor) is always adjusted to a constant K.

These and other advantages of the present invention will no doubt become obvious to those of ordinary skill in the art after having read the following detailed description of the preferred embodiments, which are illustrated in the various drawing and figures.

### BRIEF DESCRIPTION OF THE DRAWINGS

The accompanying drawings, which are incorporated in and form a part of this specification, illustrate embodiments of the invention and, together with the description, explain the principles of the invention.

FIG. 1 illustrates a block diagram of a DC-DC converter system including a control circuit connected to a DC-DC converter consisting of a plurality of DC-DC boost circuits in accordance to an exemplary embodiment of the invention.

FIG. 2 shows a schematic diagram of a step-up DC-DC converter circuit in accordance to an exemplary embodiment of the invention.

FIG. 3A illustrates the operating principle of the DC-DC converter circuit in the first cycle (t₀-t₁) when all DC-DC boost converter stages operate properly in accordance with an exemplary aspect of the present invention.

FIG. 3B illustrates the operating principle of the DC-DC converter circuit in the second cycle (t₁-t₂) when all DC-DC boost converter stages operate properly in accordance with an exemplary aspect of the present invention.

FIG. 4A shows the control pulses SW1-SW4 input to the MOSFETs in accordance with an exemplary aspect of the invention.

FIG. 4B illustrates the operation of the DC-DC converter when all DC-DC boost converter stages operate properly in accordance with to an exemplary aspect of the invention

FIG. 5A-FIG. 5B show the input (Vᵢₙ) and output voltages (Vₒᵤₜ) when all DC-DC boost converter stages operate properly in accordance to an exemplary aspect of the invention.

FIG. 6A illustrates control pulses of N control switches when the first switch (e.g., the MOSFET) fails in accordance with an exemplary situation of the invention.

FIG. 6B illustrates the operation of the DC-DC converter when the first MOSFET switch fails in accordance with an exemplary situation of the invention.

FIG. 7A-FIG. 7B show the input (Vᵢₙ) and output (Vₒᵤₜ) voltage signals when the first MOSFET switch fails in accordance with an exemplary situation of the invention.

FIG. 8A illustrates control pulses SW1-SW4 when the second MOSFET switch fails in accordance to an exemplary situation of the invention.

FIG. 8B illustrates the operations of the DC-DC boost converter when the second MOSFET switch fails in accordance with an exemplary situation of the invention.

FIG. 9A-FIG. 9B show the input (Vᵢₙ) and output (Vₒᵤₜ) signals when the second the second MOSFET switch fails in accordance with an exemplary situation of the invention.

FIG. 10A illustrates control pulses SW1-SW4 when the first and second MOSFET switches fail in accordance with an exemplary situation of the invention.

FIG. 10B illustrates the operations of the DC-DC boost converter when the first and second MOSFET switches fail in accordance to an exemplary situation of the invention.

FIG. 11A-FIG. 11B show the input (Vᵢₙ) and output (Vₒᵤₜ) signals when the first and second MOSFET switches fail in accordance to an exemplary situation of the invention.

FIG. 12A illustrates control pulses SW1-SW4 when the first and third MOSFET switches fail in accordance to an exemplary aspect of the invention.

FIG. 12B illustrates the operations of the DC-DC boost converter when the first and third MOSFET switches fail in accordance with an exemplary situation of the invention.

FIG. 13A-FIG. 13B show the input (Vᵢₙ) and output (Vₒᵤₜ) signals when the first and MOSFET switches fail in accordance to an exemplary situation of the present invention.

FIG. 14 shows a method for constructing a reliable DC-DC converter circuit that has a constant gain factor k as long as at least one MOSFET switches operates properly in accordance with various exemplary aspects of the present invention.

FIG. 15 shows a flowchart of an algorithm when executed by the controller circuit ensures the DC-DC boost circuit operates properly in accordance with an exemplary aspect of the present invention.

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Within the scope of the present description, the reference to “an embodiment” or “the embodiment” or “some embodiments” means that a particular feature, structure, or element described with reference to an embodiment is comprised in at least one embodiment of the described object. The sentences “in an embodiment,” “in the embodiment,” or “in some embodiments” in the description do not, therefore, necessarily refer to the same embodiment or embodiments. The features, structures, or elements can be furthermore combined in any adequate way in one or more embodiments.

The present invention provides a method and device for a reliable DC-DC converter circuit. In various embodiments of the present invention, a controller circuit is installed with an algorithm, when executed, assists the DC-DC converter circuit to operate efficiently and reliably.

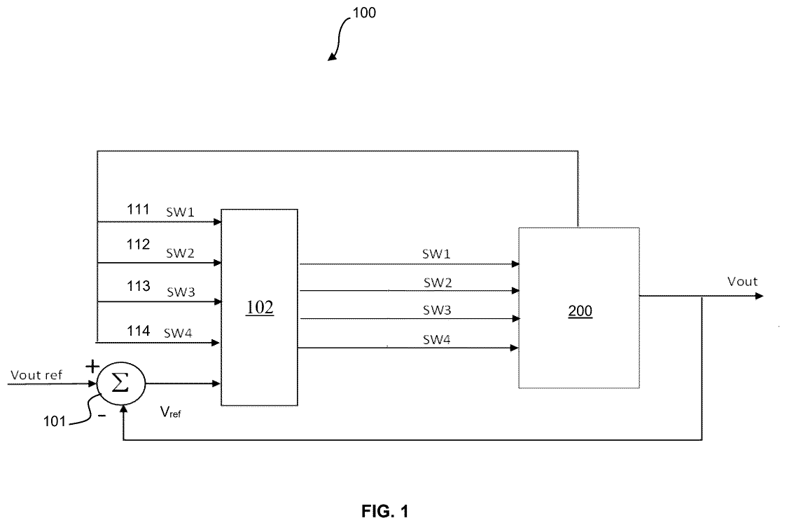

Now referring to FIG. 1, a block diagram of a DC-DC converter circuit 100 including a controller circuit in accordance to an exemplary embodiment of the invention is illustrated. DC-DC converter circuit 100 includes a summer circuit 101, a controller circuit 102 and a DC-DC converter circuit 200. Summer circuit 101 is an operational amplifier (op-amp) designed to receive an input voltage (Vᵢₙ) at its positive terminal. A feedback reference voltage (V_{ref}) from the output of DC-DC boost converter circuit 200 is fed back to the negative terminal of summer circuit 101. A plurality of control voltages SW1 111, SW2 112, SW3 113, and SW4 114 are input to controller circuit 102 and DC-DC converter circuit 200. It is noted that in the present invention, DC-DC converter circuit 200 is a DC-DC step-up (or boost) converter. However, DC-DC step-down (or buck) converters that operate in the same principle described below are within the scope of the present invention.

Continuing with FIG. 1, controller circuit 102 is a microprocessor or an application specific integrated circuit (ASIC). Controller circuit 102 contains a non-transitory proportional integral (PI) algorithm in its memory. This PI algorithm when executed will perform the following steps:

### 1. Set Up the Constants:

kₚ=0.000008: proportional gain.

kⱼ=0.00000002: integral gain.

### 2. Declare Variables:

V_{bus}: current error of DC-DC boost converter.

V_{busprev}: previous error of the system (to calculate the integral component).

integral: integral value of the error.

V_{ref}=311: reference voltage value of DC-DC boost converter.

k=300: overall gain.

### 3. Calculate the Error

V_{bus}=V_{ref}−x₁: calculate the error by subtracting the measured voltage value (x₁) from the reference voltage value.

### 4. Calculate the Integral Component:

integral=integral+V_{bus}*kᵢ+V_{busprev}*kᵢ: Add the current error and the previous error, then multiply by the integral gain.

### 5. Update the Previous Error:

V_{busprev}=V_{bus}: save the current error value for use in the next calculation.

### 6. Calculate the Control Signal (y₁):

y₁=(V_{bus}*kₚ)+integral: multiply the error by the proportional gain and add the integral component.

### 7. Limit the Control Signal:

if (y₁>0.8) y₁=0.8: If the control signal exceeds 0.8, limit it to 0.8.

if (y₁<0.2) y₁=0.2: If the control signal is less than 0.2, limit it to 0.2.

### 8. Amplify the Control Signal:

y₁=y₁*k: multiply the control signal with the overall amplification factor

$${y}_{2} = {x}_{2}$$

$${y}_{3} = {x}_{3}$$

$${y}_{4} = {x}_{4}$$

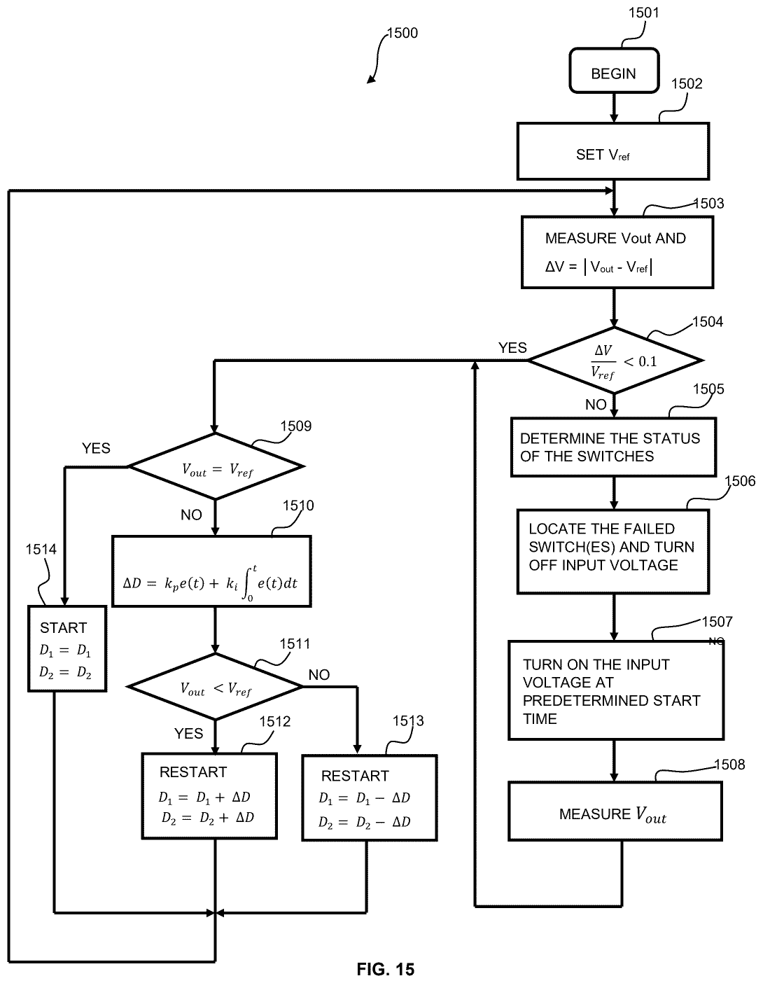

The above steps are implemented by the following programming codes stored in controller circuit 102. Please refer to FIG. 15 for more details.

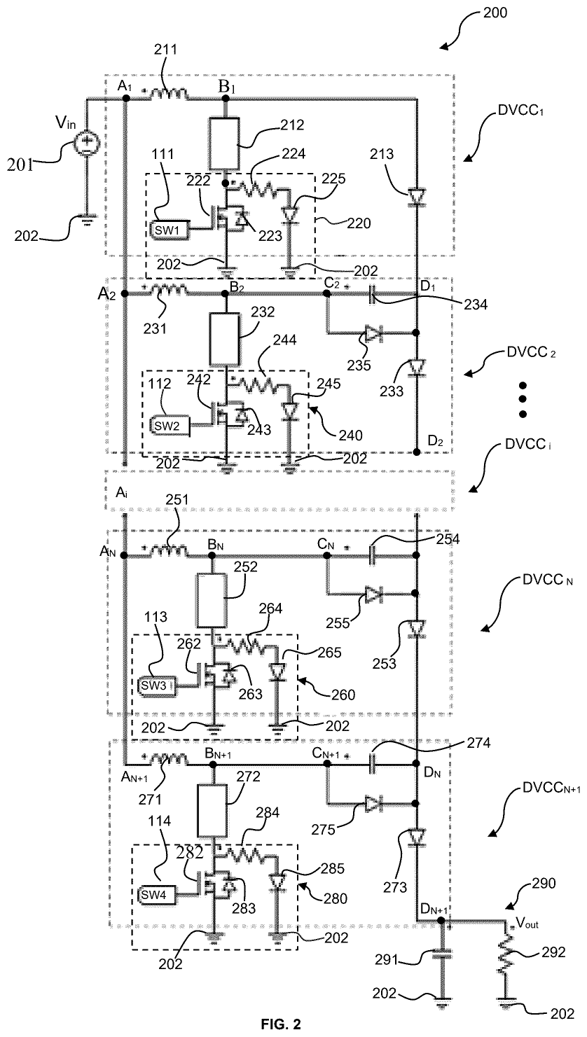

Next referring to FIG. 2, a schematic diagram of a DC-DC step-up (boost) converter circuit 200 in accordance to an exemplary embodiment of the invention is illustrated. DC-DC boost converter circuit 200 (hereinafter referred to as converter 200) includes N boost converter stages DVCC₁, DVCC₂, . . . , DVCC_{N}, and DVCC_{N+1} coupled together in parallel, where N is a positive integer. The topology of each DVCC₁-DVCC_{N+1} is described below.

Structurally, DC-DC boost converter stage DCCV₁ includes an input terminal at node A₁ and an output terminal at node D₁. An input voltage Vᵢₙ 201 is connected to an inductor 211 at node A₁. An electrical fuse 212 is connected to the output end of inductor 211 at node B₁. The output of electrical fuse 212 is connected to a switching circuitry 220. Switching circuitry 220 includes a resistor 224 which is connected in series to a photo diode 225. The anode of photo diode 225 is connected to an electrical ground 202. The output of electrical fuse 212 is also connected to a drain terminal of a MOSFET switch 222. The gate of MOSFET switch 222 is connected to a first switching control voltage SW1 111. The source of MOSFET 222 is connected to electrical ground 202. A body diode 223 is shown across the source-drain of MOSFET switch 222. The output terminal of inductor 211 at node B₁ is connected to a diode 213. The anode of diode 213 forms an output terminal at node D₁.

Continuing with FIG. 2, DC-DC boost converter stage DCCV₂ includes an input terminal at node A₂ and an output terminal at node D₂. Input terminal at node A₂ is connected to node A₁ which is connected to an inductor 231. An electrical fuse 232 is connected to the output end of inductor 231 at node B₂. The output of electrical fuse 232 is connected to a switching circuitry 240. Switching circuitry 240 includes a resistor 244 which is connected in series to a photodiode 245. The anode of photodiode 245 is connected to an electrical ground 202. The output of electrical fuse 232 is also connected to a drain terminal of a MOSFET switch 242. The gate of MOSFET 242 is connected to second switching control voltage SW2 112. The source of MOSFET 242 is connected to electrical ground 202. A body diode 243 is shown across the source-drain of MOSFET switch 242. The output terminal of inductor 231 is connected to a capacitor 234 and also to a diode 235 at node C₂. The outputs of both capacitor 234 and diode 235 are connected to a second diode 233. The anode of second diode 233 forms an output terminal at node D₂.

Still referring to FIG. 2, DC-DC boost converter stage DCCV_{N} includes an input terminal at node A_{N} and an output terminal at node D_{N}. Input terminal at node A_{N} is connected to previous node Aᵢ which is connected to an inductor 251. An electrical fuse 252 is connected to the output end of inductor 251 at node B_{N}. The output of electrical fuse 252 is connected to a switching circuitry 260. Switching circuitry 260 includes a resistor 264 which is connected in series to a photodiode 265. The anode of photodiode 265 is connected to an electrical ground 202. The output of electrical fuse 252 is also connected to a drain terminal of a MOSFET switch 262. The gate of MOSFET switch 262 is connected to third switching control voltage SW₃ 113. The source of MOSFET switch 262 is connected to electrical ground 202. A body diode 263 is shown across the source-drain of MOSFET switch 262. The output terminal of inductor 251 is connected to a capacitor 254 and also to a first diode 255 at node C_{N}. The outputs of both capacitor 254 and first diode 255 are connected to second diode 253. The anode of second diode 253 forms an output terminal at node D_{N}.

Still referring to FIG. 2, DC-DC converter stage DCCV_{N+1} includes an input terminal at node A_{N+1} and an output terminal at node D_{N+1}. Input terminal at node A_{N+1} is connected to previous node A_{N} which is connected to an inductor 271. An electrical fuse 272 is connected to the output end of inductor 271. The output of electrical fuse 272 is connected to a switching circuitry 280. Switching circuitry 280 includes a resistor 284 which is connected in series to a photodiode 285. The anode of photodiode 285 is connected to an electrical ground 202. The output of electrical fuse 272 is also connected to a drain terminal of a MOSFET switch 282. The gate of MOSFET 282 is connected to fourth control voltage SW4 114. The source of MOSFET switch 282 is connected to electrical ground 202. A body diode 283 is shown across the source-drain of MOSFET 282. The output terminal of inductor 271 is connected to a capacitor 274 and also to a first diode 275 at node D_{N+1}. The outputs of both capacitor 274 and first diode 275 are connected to second diode 273 at node C_{N+1}. The anode of second diode 273 forms an output terminal at node D_{N+1}. Output terminal node D_{N+1} is connected to an output stage 290 which includes a capacitor 291 which is connected in parallel to a load resistor 292. The other terminals of output capacitor 291 and load resistor 292 are connected to electrical ground 202.

In operation, because of the above topography of DVCC₁, DCCV₂, . . . , DCCV_{N}, and DCCV_{N+1}, converter circuit 200 of the present invention achieves a constant duty cycle even though (N−1) DCCV stages fail. When any of MOSFET switches 222, 242, 262, and 282 fail, respective photodiodes 225, 245, 265, and 285 turn ON signaling.

Converter circuit 200 has a constant gain k:

$$k = \frac{{V}_{out}}{{V}_{s}} = \frac{N}{1 - D} ,$$

where D is duty cycle, any consecutive SW1 111 and SW2 112 and SW3 113 and SW4 114 are driven 180 degrees out of phase, and N is the number of DC-DC boost converter stages. For non-limiting examples, N in the present disclosure is set to 4.

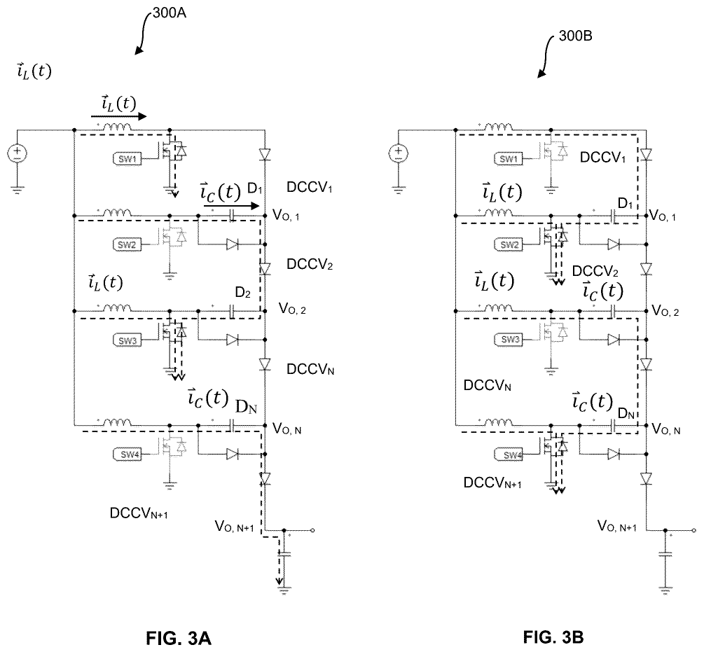

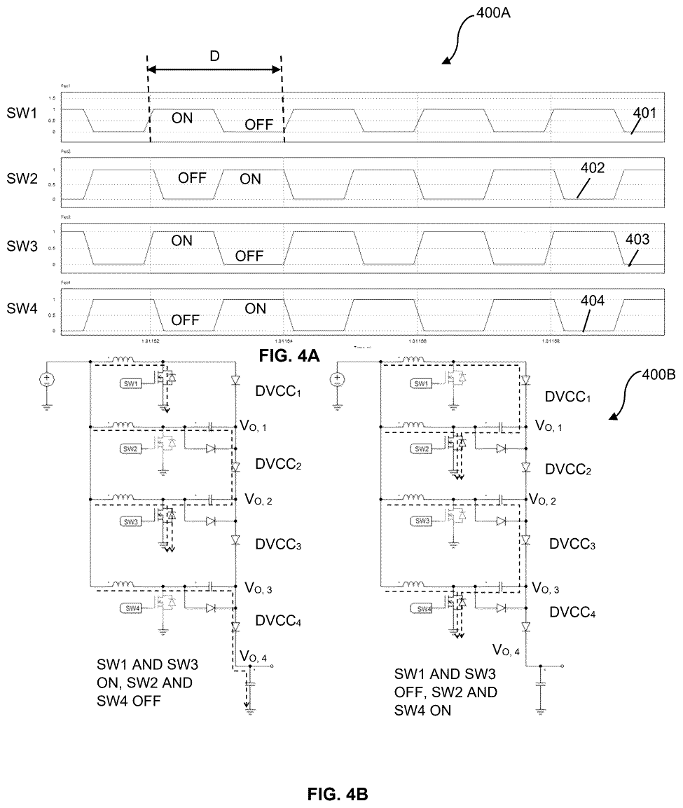

Referring next to FIG. 3A, the operating principle of the DC-DC boost converter circuit as any of consecutive pairs SW1 and SW2 and SW3 and SW4 is driven 180 degree out of phase in accordance with an exemplary aspect of the present invention is illustrated. It will be shown that irrespective of how many DVCC stages fail, the gain of converter circuit 200 is always constant and equal to

$$k = \frac{{V}_{out}}{{V}_{s}} = \frac{N}{1 - D} ,$$

where k is the voltage gain of the converter 200, Vₒᵤₜ is the output voltage at node D_{N+1} of the final stage DVCC_{N+1}, Vᵢₙ is the input voltage, D is the duty cycle. Duty cycle D is the ratio of the time the MOSFET switch is turned ON to the total switching period T. Please see FIG. 4A.

To arrive at the desired objective of the present invention, first consider the first stage DC-DC boost converter DCCV₁. During the on time the inductor current increases from its minimum value toward its maximum value. In other words, the stored energy in the inductors 222 increases during the time the switch is in the closed position. During the off time, T_{OFF}=(1−D)T, the switch is open and the inductor current is directed toward the load via directional diode 213. The inductor current \vec{iₜ}(t) therefore charges capacitor 234 and supplies the load current. Diode 213 blocks not only the current flow toward the source when control signal SW1 111 is in the closed position but also stops the output voltage from appearing across the closed switch. Inductor 211 also helps control the percent current ripple and determines whether or not the circuit is operating in the continuous conduction mode. Capacitor 234 provides the filtering action by providing a path for the harmonic currents away from the load. In addition, its value is large enough so that the output voltage ripple is very small.

The analysis begins when the inductor current \vec{iₜ}(t) is at its minimum and the switch SW1 is closed at t=0. The differential equation for the inductor current, for 0≤t≤T_{ON}=DT, and its solution are:

$$L \frac{{di}_{L} ( t )}{dt} = {V}_{in}$$

$${i}_{L} ( t ) = \frac{{V}_{in}}{L} t + {I}_{L , min}$$

According to this equation, the inductor current increases linearly and attains its maximum value I_{Lmax} as t=T_{ON}=DT such that:

$${I}_{L , max} = \frac{{V}_{in}}{L} DT + {I}_{L , min}$$

Defining the change in the current from its minimum to maximum value as the peak to-peak current ripple ΔI_{L}, the above equation yields an expression for ΔI_{L} as:

$$Δ {I}_{L} = {I}_{L , max} - {I}_{L , min} = \frac{{V}_{in}}{L} DT$$

As soon as the inductor current reaches its maximum value, the switch SW1 is opened. The inductor current now begins to supply the load current and charge the capacitor. The corresponding differential equation for T_{ON}≤t≤T is:

$$L \frac{{di}_{L}}{dt} = {V}_{in} - {V}_{out}$$

The solution of this equation yields

$${i}_{L} ( {t}^{′} ) = \frac{{V}_{in} - {V}_{out}}{L} ( t - DT ) + {I}_{L , max}$$

As per this equation, the inductor current \vec{iₜ}(t) decreases linearly from its maximum value at t=T_{ON} to its minimum value as t=T, such that

$${i}_{L , min} = \frac{{V}_{in} - {V}_{out}}{L} ( 1 - D ) T + {I}_{L , max}$$

The peak-to-peak current ripple is:

$$Δ {I}_{L} = {I}_{L , max} - {I}_{L , min} = - \frac{{V}_{in} - {V}_{out}}{L} ( 1 - D ) T$$

Two formulas found for the current ripple ΔI_{L} must be the same. Equating the two equations, the following is obtained

$$\frac{{V}_{in}}{L} DT = - \frac{{V}_{in} - {V}_{out}}{L} ( 1 - D ) T$$

This equation upon simplification yields, V_{o,1} at node D₁:

$${V}_{out} = \frac{{V}_{in}}{1 - D}$$

Referring again to FIG. 2 and FIG. 3A, with N stages DC-DC boost converter circuit 200. In the first cycle, SW1 is ON, SW2 is OFF, SW3 is ON, and SW3 is OFF. In first stage DCCV₁, inductor 211 is charged to

$${V}_{o , 1} = \frac{{V}_{in}}{1 - D} ;$$

in second stage DCCV₂, capacitor is charged up to

$${V}_{o , 2} = \frac{{V}_{i n}}{1 - D} ;$$

in DCCV_{N} stage, inductor 251 is charged up to

$${V}_{o , N} = \frac{{V}_{i n}}{1 - D} ;$$

and in DCCV_{N+1} stage, capacitor is charged to

$${V}_{o , N + 1} = \frac{{V}_{i n}}{1 - D} .$$

The output voltage Vₒᵤₜ at output capacitor 291 at node D_{N+1} is always:

$${V}_{o u t} = \frac{N {V}_{i n}}{1 - D}$$

$${V}_{o u t} = N \frac{{V}_{i n}}{1 - D}$$

because the output voltage (Vo) at node D_{N+1} is always the sum of V_{o,1} at node D₁, V_{o,2} at node D₂; V_{o,N} at node D_{N}; and V_{o,N+1} at node D_{N+1}.

Referring to FIG. 3B and FIG. 2, in the next cycle, SW1 111 is OFF, SW2 112 is ON, SW3 113 is OFF, and SW4 114 is ON. In first stage DCCV₁, capacitor 234 is charged to

$${V}_{o , 1} = \frac{{V}_{i n}}{1 - D} ;$$

in second stage DCCV₂, inductor 231 is charged up to

$${V}_{o , 2} = \frac{{V}_{i n}}{1 - D} ;$$

in DCCV_{N} stage, capacitor 254 is charged up to

$${V}_{o , N} = \frac{{V}_{i n}}{1 - D} ;$$

and in DCCV_{N+1} stage, inductor 271 is charged to

$${V}_{o , N + 1} = \frac{{V}_{i n}}{1 - D} .$$

The output voltage Vₒᵤₜ at output capacitor 291 at node D_{N+1} is always:

$${V}_{out} = \frac{N {V}_{i n}}{1 - D} .$$

$${V}_{O u t} = N \frac{{V}_{S}}{1 - D}$$

because the output voltage (Vₒᵤₜ) at node D_{N+1} is always the sum of V_{o,1} at node D₁, V_{o,2} at node D₂; V_{o,N} at node D_{N}; and V_{o,N+1} at node D_{N+1}.

Next referring to FIG. 4A and FIG. 4B, the operations of the DC-DC converter when all four stages operate properly without fail is illustrated. In FIG. 4A, graphs 400A show switching control signals SW1 401, SW2 402, SW3 403, and SW4 404. In many preferred embodiments of the present invention, SW1 and SW2 are 180° out of phase, SW3 and SW4 are 180° out of phase. FIG. 4B shows the operation of converter circuit 200 during the first cycle [t₀, t₁] and second cycle [t₁, t₂]. As described above in FIG. 3A-FIG. 3B, Vₒᵤₜ is always

$${V}_{out} = 4 \frac{{V}_{S}}{I - D} or D = 1 - \frac{N {V}_{i n}}{{V}_{o u t}} .$$

Controller circuit 102 only interferes when it senses by feedback reference signal V_{ref} that converter circuit 200 fails to operate. The PI algorithm shown above and in FIG. 15 are used.

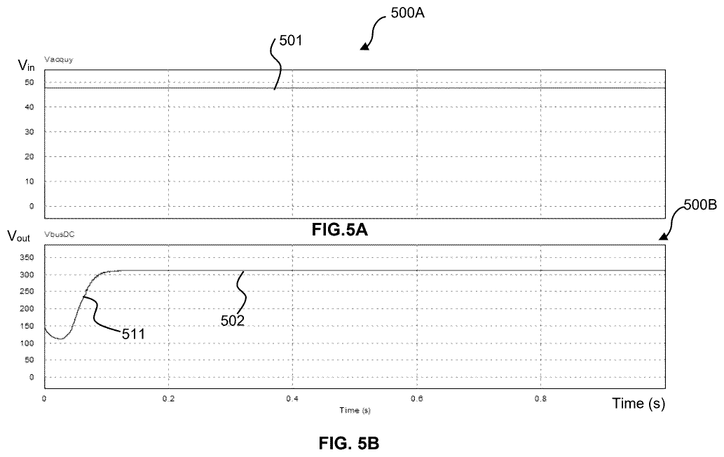

FIG. 5A-FIG. 5B, a graph 500 of Vᵢₙ and Vₒᵤₜ when all stages operate properly is illustrated. SW1-SW4 control pulses of N control switches when the DC-DC converter operates properly. In FIG. 5A, a Vᵢₙ graph 501 is a constant DC voltage. In FIG. 5B, Vₒᵤₜ graph 502 is also a DC voltage at a higher voltage level with gain k. A voltage drop 511 indicates the time it takes to charge the inductors and capacitors of converter 200.

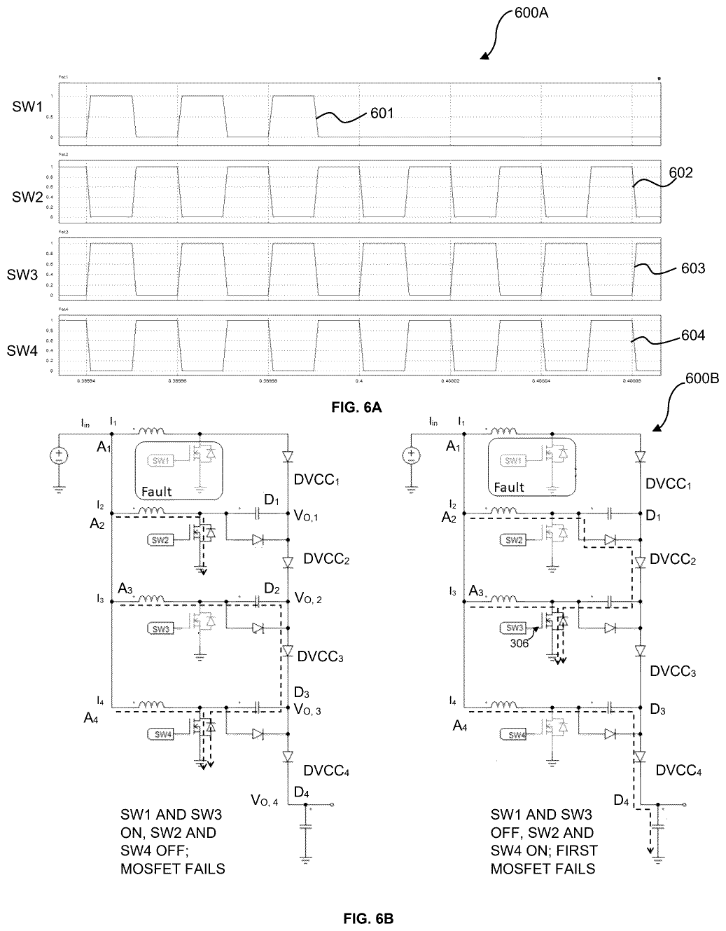

Referring now to FIG. 6A, switching control pulses SW1-SW4 600A with duty cycle D when the first MOSFET fails in accordance to an exemplary aspect of the invention is illustrated. As shown, SW1 601 drops to 0V after the third pulse. This is equivalent to MOSFET 222 fails after the third pulse.

In FIG. 6B, when MOSFET 222 fails, inductor 211 is not charged up. That is no current [symbol] (t) flows through inductor 211. However, capacitor 234 is charged up because Vᵢₙ is also applied at node A₂. In switching circuitry 220, MOSFET 222 is OFF and photodiode 225 is turned ON signaling that MOSFET 222 has failed. Diode 213 is ON, charging capacitor 234. The output voltage V_{o,1} at node D₁ is still

$${V}_{o , 1} = \frac{{V}_{i n}}{1 - D} .$$

The output voltage V_{o,2} at node D₂ is still

$${V}_{o , 2} = \frac{{V}_{i n}}{1 - D} .$$

Similarly, The output voltage V_{o,3} at node D₃ is still

$${V}_{o , 3} = \frac{{V}_{i n}}{1 - D} .$$

The output voltage V_{o,4} at node D₄ is still

$${V}_{o , 4} = \frac{{V}_{i n}}{1 - D} .$$

Therefore, the final output voltage is still

$${V}_{out} = \frac{4 {V}_{i n}}{1 - D} .$$

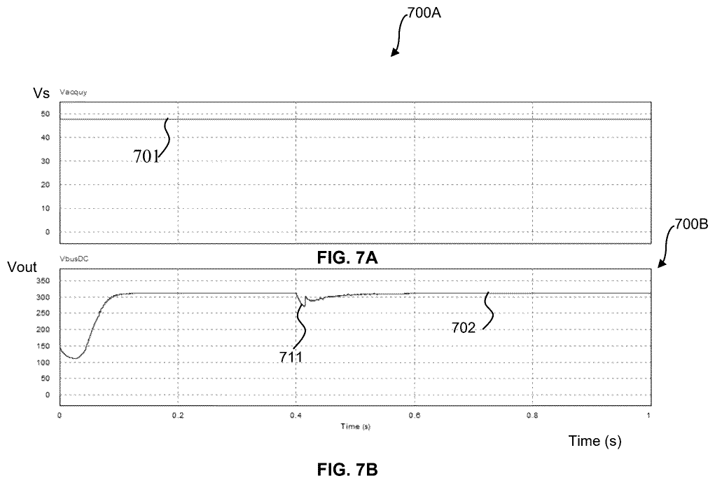

FIG. 7A-FIG. 7B, a graph 700 of Vᵢₙ and Vₒᵤₜ voltages when the first MOSFET fails is shown. In FIG. 7A, a Vᵢₙ graph 701 is a constant DC voltage. In FIG. 7B, a Vₒᵤₜ graph 702 is also a DC voltage at a higher voltage level because of gain k. A ringing 711 is manifested by currents fluctuations within first DC-DC boost converter stage DVVC₁.

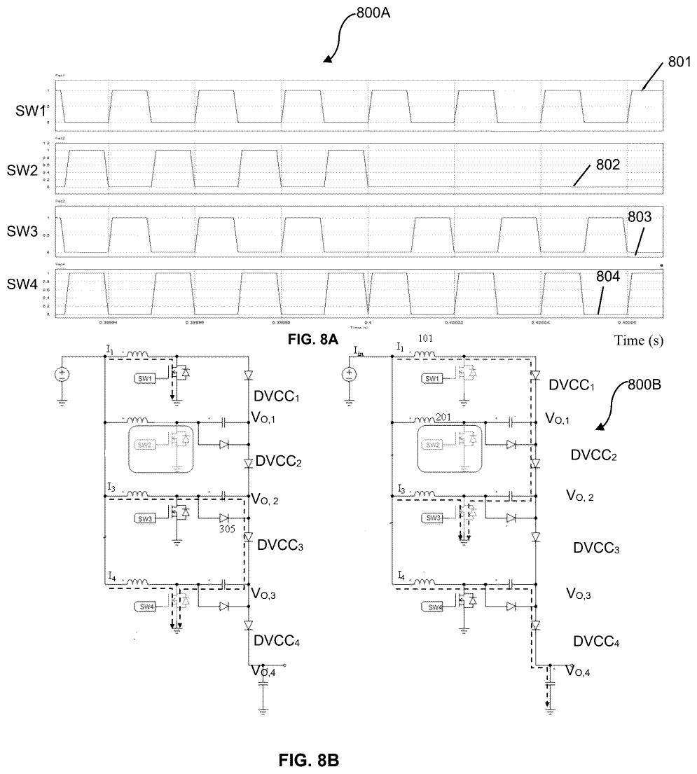

Next, an exemplary situation when the second MOSFET fails is illustrated in FIG. 8A-FIG. 8B. In FIG. 8A, SW1-SW4 switching control pulses SW1-SW4 800A in case second MOSFET 242 fails are shown. SW1 802 drops to 0V after the fourth pulse. This is equivalent to MOSFET switch 242 fails.

In FIG. 8B, when MOSFET switch 242 fails and inductor 231 is not charged up. That is no current [symbol] (t) flows through inductor 231. However, capacitor 234 is charged up by current [symbol] (t) because of directional diode 235. The output voltage V_{o,1} at node D₁ is still

$${V}_{o , 1} = \frac{{V}_{i n}}{1 - D} .$$

The output voltage V_{o,2} at node D₂ is still

$${V}_{o , 2} = \frac{{V}_{i n}}{1 - D} .$$

Similarly, The output voltage V_{o,3} at node D₃ is still

$${V}_{o , 3} = \frac{{V}_{i n}}{1 - D} .$$

The output voltage V_{o,4} at node D_{N+1} is still

$${V}_{o , 4} = \frac{{V}_{i n}}{1 - D} .$$

Therefore, the final output voltage

$${V}_{out} = \frac{{NV}_{i n}}{1 - D} .$$

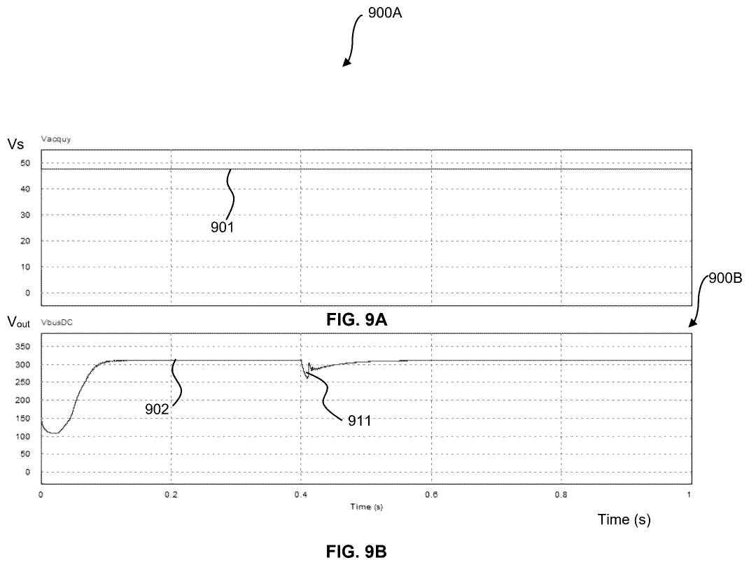

FIG. 9A-FIG. 9B, a graph 900 of Vᵢₙ and Vₒᵤₜ is illustrated. SW1-SW4 switching control pulses SW1-SW4 when the second MOSFET switch fails. In FIG. 9A, a Vᵢₙ graph 901 is a constant DC voltage. In FIG. 9B, a Vₒᵤₜ graph 902 is also a DC voltage at a higher DC voltage level because of gain k. A ringing 911 is manifested by current fluctuations within second DC-DC boost converter stage DVVC₂.

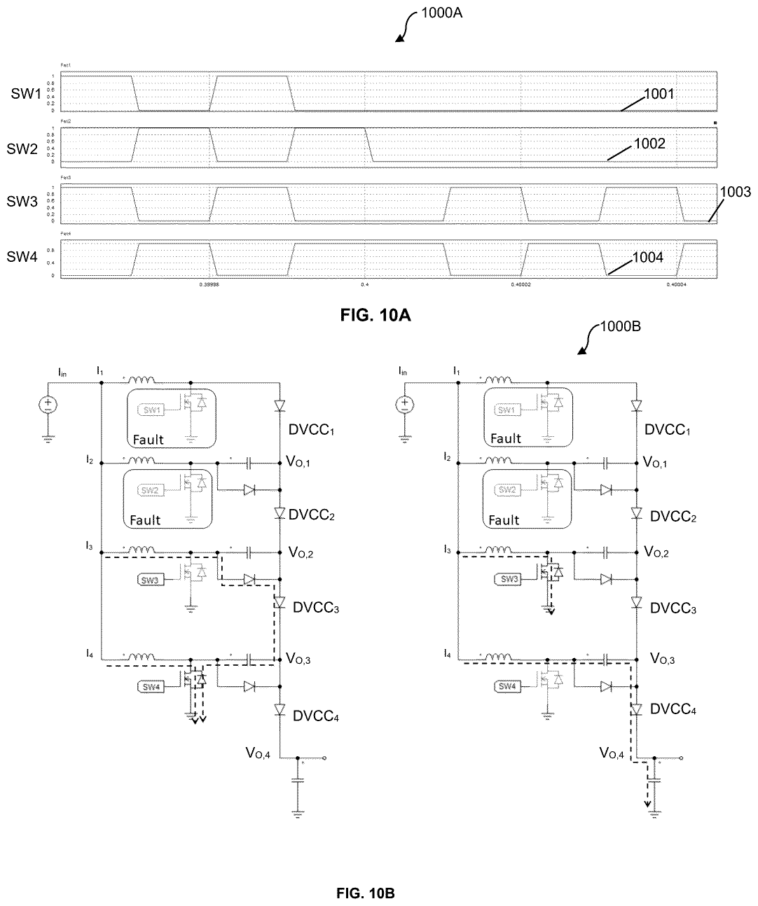

Now referring to FIG. 10A-FIG. 10B, an exemplary situation when the first and second MOSFET switches fail are discussed. When both first and second MOSFETs fail, the output voltage Vₒᵤₜ remains the same. In FIG. 10A, control pulses SW1-SW4 1000A when first and second MOSFETs 222 and 242 fail are illustrated. First switching control signal SW1 1001 drops to 0V after the second pulse. Second switching control signal SW2 1002 drops to zero volt after the third pulse. This is equivalent to MOSFET 222 and 242 fail concurrently.

In FIG. 10B, when MOSFET 222 fails, inductor 211 is not charged up. That is no current [symbol] (t) flows through inductor 211. However, capacitor 234 is charged up by current [symbol] (t). The output voltage V_{o,1} at node D₁ is still

$${V}_{o , 1} = \frac{{V}_{i n}}{1 - D} .$$

In the second stage DVCC₂, the output voltage V_{o,2} at node D₂ is still

$${V}_{o , 2} = \frac{{V}_{i n}}{1 - D} .$$

Similarly, The output voltage V_{o,3} at node D₃ is still

$${V}_{o , 3} = \frac{{V}_{i n}}{1 - D} .$$

The output voltage V_{o,4} at node D₁ is still

$${V}_{o , 4} = \frac{{V}_{i n}}{1 - D} .$$

Therefore, the final output voltage

$${V}_{out} = \frac{4 {V}_{i n}}{1 - D} .$$

When second MOSFET switch 242 fails the same phenomenon happened as described above in FIG. 8A-FIG. 8B;

$${V}_{out} = \frac{4 {V}_{i n}}{1 - D} .$$

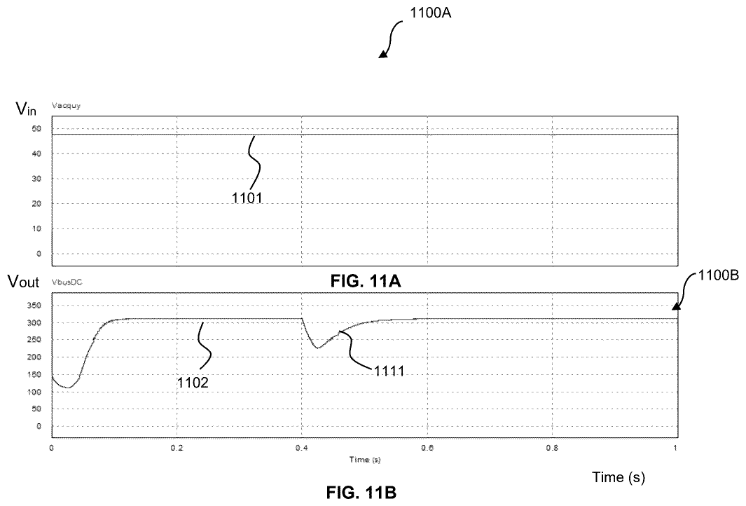

FIG. 11A-FIG. 11B, a graph 1100A of Vᵢₙ and Vₒᵤₜ when the first and the second MOSFETs fail is illustrated. In FIG. 11A, a Vᵢₙ graph 1101 is a constant DC voltage. In FIG. 11B, a Vₒᵤₜ graph 1102 is also a DC voltage at a higher voltage level with a gain k. A small voltage dip 1111 manifests the time it takes to recover from the failures of the first MOSFET switch 222 and second MOSFET switch 242.

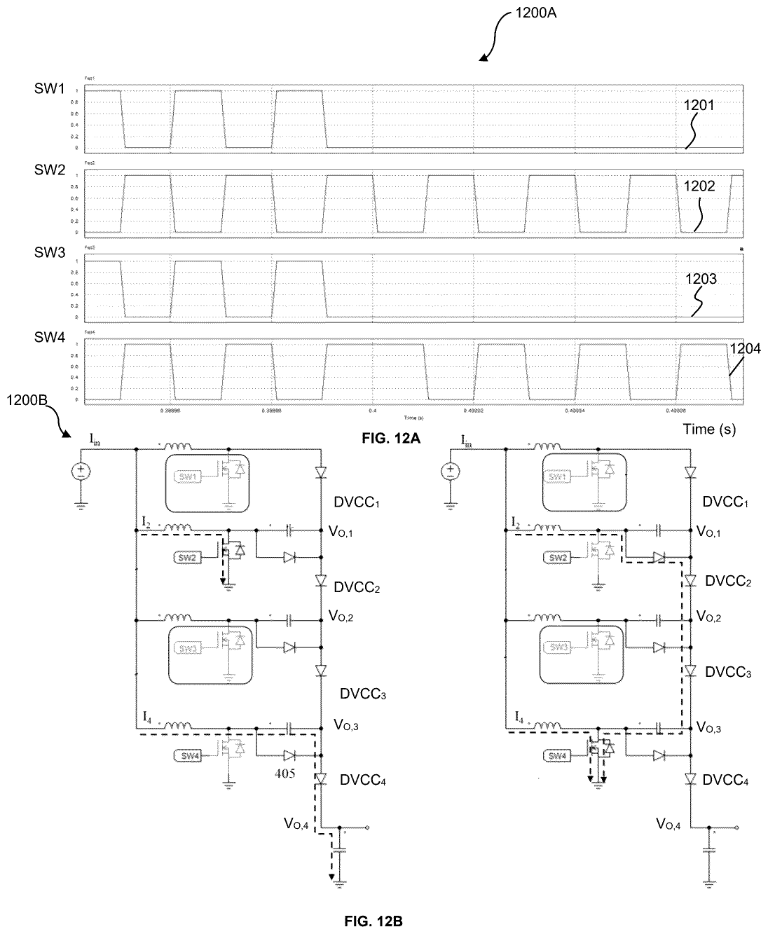

Now referring to FIG. 12A, switching control pulses SW1-SW4 1200A when the first and third MOSFET fail are shown. An exemplary situation where the first and the third MOSFET switch fail are shown and discussed in FIG. 12A-FIG. 12B. The output voltage Vₒᵤₜ is still

$${V}_{out} = \frac{4 {V}_{i n}}{1 - D} .$$

Switching control signal SW1 1201 drops to 0V after second pulse. Switching control signal SW2 1203 drops to zero volt after the third pulse. This is equivalent to MOSFET 222 and 262 fail at the same time.

In FIG. 12B, when MOSFET 222 fails, inductor 211 is not charged up. That is no current [symbol] (t) flows through inductor 211. However, capacitor 234 is charged up by current [symbol] (t). The output voltage V_{o,1} at node D₁ is still

$${V}_{o , 1} = \frac{{V}_{i n}}{1 - D} .$$

In the second stage DVCC₂, the output voltage V_{o,2} at node D₂ is still

$${V}_{o , 2} = \frac{{V}_{in}}{1 - D} .$$

Similarly, The output voltage V_{o,3} at node D₃ is still

$${V}_{o , 3} = \frac{{V}_{in}}{1 - D} .$$

The output voltage V_{o,4} at node D₄ is still

$${V}_{o , 4} = \frac{{V}_{in}}{1 - D} .$$

Therefore, the final output voltage

$${V}_{out} = \frac{4 {V}_{in}}{1 - D} .$$

In addition, the same phenomena happens in second DC-DC boost converter stage DVCC₃:

$${V}_{o , 4} = \frac{{V}_{in}}{1 - D} and {V}_{out} = \frac{4 {V}_{in}}{1 - D} .$$

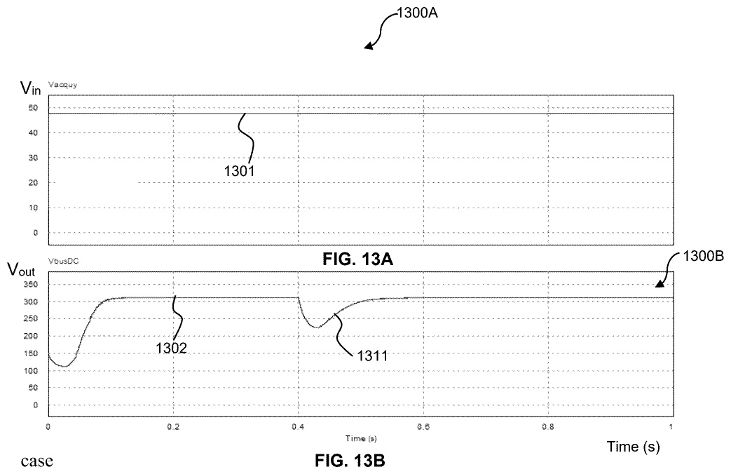

Referring to FIG. 13A-FIG. 13B, a graph 1300A of Vᵢₙ and a graph 1300B of Vₒᵤₜ in case first MOSFET switch and third MOSFET switch fail are illustrated. In FIG. 13A, a Vᵢₙ graph 1301 is an input constant DC voltage. In FIG. 13B, a Vₒᵤₜ graph 1302 is also a DC voltage at a higher voltage level. A small voltage dip 1311 is caused by the recovery time it takes to recover from the failure state to normal state of the first stage DCCV₁ and the third stage DCCV₃.

Above are exemplary cases when various MOSFETs of converter 200 fails. Table 1 below summarizes situation when at least one MOSFET operate properly. Even when all three MOSFETs fail, converter 200 still provides the same gain and voltage output (Vout).

TABLE 1
Operation of DC-DC Boost Converter When Various MOSFETs Fail are Summarized.

| | | | | | | Control | | | |
|---|---|---|---|---|---|---|---|---|---|
| | Number | Status of Switching | | | | Switches | | | |
| | of | Devices : | | | | (D1 and D2 | | | |
| Case | Broken | [symbol] : Operating | | | | 180º Out of | | Duty Cycle D | Illustrating |
| No. | Switches | [symbol] : Broken | | | | Phase) | | D1 = D2 = D | Figures |
| (1) | (2) | (3) | | | | (4) | | (5) | FIG. 2-FIG. 13 |
| | | SW | SW | SW | SW | D1 | D2 | | |
| | | 1 | 2 | 3 | 4 | | | | |
| 1 | 0 | [symbol] | [symbol] | [symbol] | [symbol] | SW 1, | SW 2, | $D = 1 - \frac{4 {V}_{in}}{{V}_{out}}$ | FIG. 3 |
| | | | | | | SW | SW | | |
| | | | | | | 3 | 4 | | |
| 2 | 1 | [symbol] | [symbol] | [symbol] | [symbol] | SW 2, | SW 3 | $D = 1 - \frac{3 {V}_{in}}{{V}_{out}}$ | FIG. 4 |
| | | | | | | SW | | | |
| | | | | | | 4 | | | |
| 3 | 1 | [symbol] | [symbol] | [symbol] | [symbol] | SW 1, | SW 3 | $D = 1 - \frac{3 {V}_{in}}{{V}_{out}}$ | FIG. 8 |
| | | | | | | SW | | | |
| | | | | | | 4 | | | |
| 4 | 1 | [symbol] | [symbol] | [symbol] | [symbol] | SW 1, | SW 2 | $D = 1 - \frac{3 {V}_{in}}{{V}_{out}}$ | FIG. 3 |
| | | | | | | SW | | | |
| | | | | | | 4 | | | |
| 5 | 1 | [symbol] | [symbol] | [symbol] | [symbol] | SW 1, | SW 2 | $D = 1 - \frac{3 {V}_{in}}{{V}_{out}}$ | FIG. 3 |
| | | | | | | SW | | | |
| | | | | | | 3 | | | |
| 6 | 2 | [symbol] | [symbol] | [symbol] | [symbol] | SW 3 | SW 4 | $D = 1 - \frac{2 {V}_{in}}{{V}_{out}}$ | FIG. 10 |
| 7 | 2 | [symbol] | [symbol] | [symbol] | [symbol] | SW 1 | SW 4 | $D = 1 - \frac{2 {V}_{in}}{{V}_{out}}$ | FIG. 3 |
| 8 | 2 | [symbol] | [symbol] | [symbol] | [symbol] | SW 1 | SW 2 | $D = 1 - \frac{2 {V}_{in}}{{V}_{out}}$ | FIG. 10 |
| 9 | 2 | [symbol] | [symbol] | [symbol] | [symbol] | SW 2 | SW 3 | $D = 1 - \frac{2 {V}_{in}}{{V}_{out}}$ | FIG. 3 |
| 10 | 2 | [symbol] | [symbol] | [symbol] | [symbol] | SW 1 | SW 3 | $D = 1 - \frac{2 {V}_{in}}{{V}_{out}}$ | FIG. 3 |
| 11 | 2 | [symbol] | [symbol] | [symbol] | [symbol] | SW 2 | SW 4 | $D = 1 - \frac{2 {V}_{in}}{{V}_{out}}$ | FIG. 12-FIG. 13 |
| 12 | 3 | [symbol] | [symbol] | [symbol] | [symbol] | SW 4 | N/A | $D = 1 - \frac{{V}_{in}}{{V}_{out}}$ | FIG. 3 |
| 13 | 3 | [symbol] | [symbol] | [symbol] | [symbol] | SW 1 | SW 4 | $D = 1 - \frac{{V}_{in}}{{V}_{out}}$ | FIG. 3 |
| 14 | 3 | [symbol] | [symbol] | [symbol] | [symbol] | SW 2 | N/A | $D = 1 - \frac{{V}_{in}}{{V}_{out}}$ | FIG. 3 |
| 15 | 3 | [symbol] | [symbol] | [symbol] | [symbol] | SW 3 | N/A | $D = 1 - \frac{{V}_{in}}{{V}_{out}}$ | FIG. 3 |
| 16 | 4 | [symbol] | [symbol] | [symbol] | [symbol] | N/A | N/A | N/A | N/A |

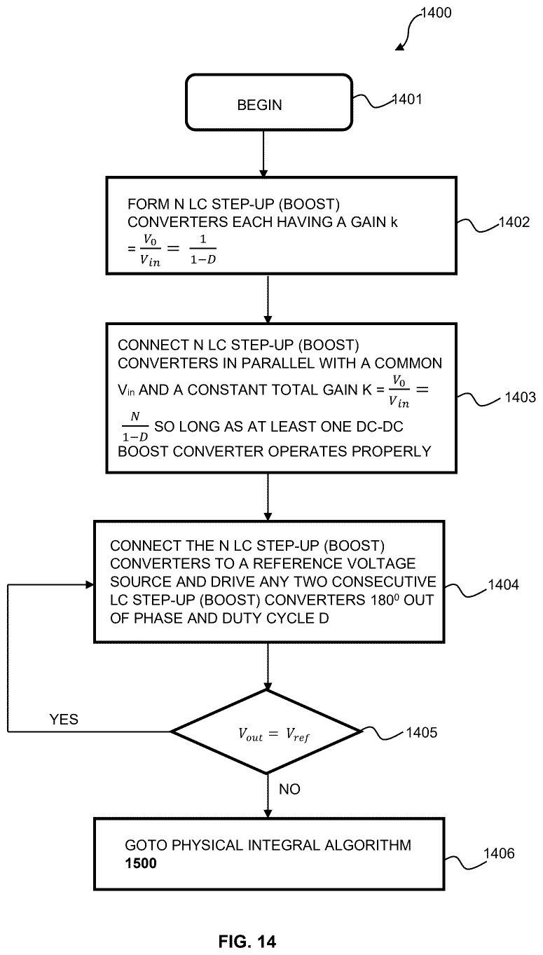

FIG. 14 shows a method 1400 for constructing a reliable DC-DC converter circuit that has a constant gain factor k as long as at least one DC-DC boost converter stage operates properly in accordance with an exemplary aspect of the present invention.

At step 1401, method 1400 begins.

At step 1402, N step-up or boost converter stages where each with a gain

$$k = \frac{{V}_{0}}{{V}_{in}} = \frac{1}{1 - D}$$

are constructed. Step 1402 is realized by forming any number of boost converter stages including first stage DVVC₁-DVCC_{N+1} as described in FIG. 2.

At step 1403, connected N step-up or boost converter stages in parallel with a common Vᵢₙ and a constant gain

$$K = \frac{{V}_{0}}{{V}_{in}} = \frac{N}{1 - D}$$

so long as each stage operates properly. Step 1403 is realized by converter 200 as described in FIG. 2, and FIG. 3 to FIG. 13B.

At step 1404, any pair of consecutive stages are driven 180° out of phase with a signal having a duty cycle D. Step 1404 is realized by controller circuit 102 with driving voltage Vᵢₙ described in FIG. 4A-FIG. 4B to FIG. 13A-FIG. 13B.

At step 1405, whether the converter circuit operates properly. Step 1405 is realized by comparing output voltage Vₒᵤₜ and the reference voltage V_{ref} If these two voltages are the same then converter circuit operates properly as described above.

Otherwise, at step 1406, go to algorithm 1500.

Referring finally to FIG. 15, a flowchart of an algorithm 1500 for ensuring the boost converter circuit operates reliably. Algorithm 1500 is executed by controller circuit 102. In various embodiments of the present invention, algorithm 1500 is a proportional integral (PI) algorithm. As shown in FIG. 1, V_{ref} is a feedback signal from the output of converter circuit 200. Algorithm 1500 is executed when V_{ref} notifies that converter circuit 200 fails to operate as described above in FIG. 3 to FIG. 13A-FIG. 13B. This PI algorithm 1500 when executed will perform the following steps:

At step 1501, algorithm 1500 begins.

At step 1502, converter constants and V_{ref} are set up. Proportional gain kₚ is set at 0.000008; integral gain kⱼ=0.00000002. In addition, other variables are also declared and set up.

V_{bus}: current error of DC-DC boost converter.

V_{busprev}: previous error of the system (to calculate the integral component).

Integral: integral value of the error.

V_{ref}=311: reference voltage value of DC-DC boost converter.

k=300: overall gain.

At step 1503, output voltage Vₒᵤₜ and error voltage ΔV=|Vₒᵤₜ−V_{ref}| are calculated. Other signals are also calculated: V_{bus}=V_{ref}−x₁. Integral=integral+V_{bus}*kᵢ+V_{busprev}*kᵢ. The current error and the previous error are added, then multiply by the integral gain. Previous error are updated V_{busprev}=V_{bus} and then saved as current error value for use in the next calculation. Control signal (y₁) is also calculated: y₁=(V_{bus}*kₚ)+integral: multiply the error by the proportional gain and add the integral component. If (y₁>0.8) y₁=0.8: If the control signal exceeds 0.8, limit it to 0.8. If (y₁<0.2) y₁=0.2: If the control signal is less than 0.2, limit it to 0.2. Control signal y₁ is amplified y₁=y₁*k by multiplying the control signal y₁ with the overall amplification factor k. Then set y₂=x₂; y₃=x₃; and y₄=x₄

Next, at step 1504, whether the ratio

$$\frac{Δ V}{{V}_{ref}} < 0.1$$

is determined.

At step 1505, if the ratio is greater than 0.1, the operational status of MOSFET switches is determined. Step 1505 is realized by photodiodes 225, 245, 265, and 285 respectively.

At step 1506, failed MOSFET switch(es) is determined. Step 1506 is realized by photodiodes 225, 245, 265, and 285 respectively.

At step 1507, the switching control voltages SW1-SW4 are turned on at a predetermined start time.

At step 1508, output voltage Vₒᵤₜ is measured again.

At step 1509, the output voltage Vₒᵤₜ and the reference voltage V_{ref} are compared.

At step 1510, if these voltages are not the same, the differential duty cycle

$$Δ D = {k}_{p} e ( t ) + {k}_{i} {\int }_{0}^{t} e ( t ) dt$$

is calculated; where e(t) is the error voltage between output voltage Vₒᵤₜ and the reference voltage V_{ref}.

Next at step 1511, the output voltage Vₒᵤₜ and the reference voltage V_{ref} are compared again.

At step 1512, if the output voltage Vₒᵤₜ is less than the reference voltage V_{ref} then new duty cycles D is set by adding previous duty cycle to the differential duty cycle ΔD. That is, D₁=D₁+ΔD and D₂=D₂+ΔD.

At step 1513, otherwise, if output voltage Vₒᵤₜ is greater than the reference voltage V_{ref} then new duty cycles D are set by subtracting from previous duty cycle to the differential duty cycle ΔD from previous duty cycle. That is, D₁=D₁−ΔD and D₂=D₂−ΔD.

Finally, at step 1514, when the output voltage Vₒᵤₜ is the same as the reference voltage V_{ref}, then maintain the same duty cycle D.

Although the implementation options of the present invention are disclosed through the detailed description of the invention above, however, it should be understood that the invention is by no means limited to these implementation options. Experts in the same technical field admit that many other similar changes and arrangements could be made. Therefore, the scope of the invention is clearly defined to include all similar changes and arrangements within the scope of the following attached claims.

### REFERENCES

[1] Y. Koç, Y. Birbir, and H. Bodur, “Non-isolated high step-up DC/DC converters—An overview,” Alexandria Engineering Journal, vol. 61, no. 2, pp. 1091-1132, 2022.
[2] F. A. Abbas, T. A. Abdul-Jabbar, A. A. Obed, A. Kersten, M. Kuder, and T. Weyh, “A Comprehensive Review and Analytical Comparison of Non-Isolated DC-DC Converters for Fuel Cell Applications,” Energies, vol. 16, no. 8, p. 3493, 2023.
[3] H. Tarzamni et al. also synthesized and compared the applicability of non-isolated high step-up DC-DC converters (H. Tarzamni, H. S. Gohari, M. Sabahi, and J. Kyyrä, “Non-isolated high step-up dc-dc converters: comparative review and metrics applicability,” IEEE Transactions on Power Electronics, 2023).
[4] V.-A. Truong, X.-T. Luong, P.-T. Nguyen, and T.-H. Quach, “The Improvement Switching Technique for High Step-Up DC-DC Boost Converter,” Electronics, vol. 9, no. 6, p. 981, 2020.

### EXPLANATION OF REFERENCE NUMERALS

100 DC-DC converter system
101 summer circuit
102 controller circuit
111 first switching control signal SW1
112 second switching control signal SW2
113 third switching control signal SW3
114 fourth switching control signal SW4
200 DC-DC converter circuit (boost)
201 input voltage (Vᵢₙ)
202 electrical ground
211 inductor of first stage
212 electrical fuse
213 diode of first stage
220 switching circuit of first stage
222 MOSFET switch of first stage (switch)
223 body diode of MOSFET switch
224 resistor
225 photodiode
231 inductor of second stage
232 electrical fuse
233 first diode of second stage
235 second diode
240 switching circuit of second stage
242 MOSFET switch of second stage (switch)
243 body diode of MOSFET switch
244 resistor
245 photo diode
251 inductor of third stage
252 electrical fuse
253 first diode of third stage
255 second diode of third stage
260 switching circuit of third stage
262 MOSFET switch of third stage (switch)
263 body diode of MOSFET switch
264 resistor
265 photo diode
271 inductor of fourth stage
272 electrical fuse
273 first diode of fourth stage
280 switching circuit of fourth stage
282 MOSFET switch of fourth stage (switch)
283 body diode of MOSFET switch
284 resistor
285 photodiode
275 second directional diode
290 output stage
291 output capacitor
292 load resistor

1. A DC-DC step-up converter circuit, comprising:
a multistage DC-DC boost converter circuit comprising a plurality of DC-DC boost converter stages coupled together in parallel;
a controller circuit, electrically coupled to drive said multistage DC-DC boost converter circuit, wherein said controller circuit drives any consecutive DC-DC boost converter stages by signals that are 180° out of phase, and wherein each DC-DC boost converter stage has a gain k equals to
$$\frac{N}{1 - D} ,$$
where N is the number of DC-DC boost converter stages and D is the duty cycle of said signals generated by said controller circuit.

2. The DC-DC step-up converter circuit of claim 1, wherein said duty cycle D is between 0.5≤D≤1.0 and N equals to even positive number greater than 1.

3. The DC-DC step-up converter circuit of claim 2 wherein said plurality of DC-DC boost converter stages coupled so that an output voltage of said DC-DC step-up converter circuit remains constant at
$$\frac{NVs}{1 - D}$$
as long as at least one of said DC-DC boost converter stages operates.

4. The DC-DC step-up converter circuit of claim 3 wherein said plurality of DC-DC boost converter stages comprise four DC-DC boost converter stages.

5. The DC-DC step-up converter circuit of claim 4 wherein said a first DC-DC boost converter stage comprises:
a first inductor having a first terminal coupled to said input voltage Vin;
an electrical fuse coupled to a second terminal of said first inductor;
a first switch coupled to said electrical fuse, wherein said first switch is driven by said input voltage Vin; and
a first diode coupled to the second terminal of said first inductor.

6. The DC-DC step-up converter circuit of claim 5 wherein said first switch is selected from a semiconductor device consisting of MOSFET (Metal-Oxide-Semiconductor Field-Effect Transistor); JFET (Junction Field-Effect Transistor); MESFET (Metal-Semiconductor Field-Effect Transistor); IGBT (Insulated Gate Bipolar Transistor).

7. The DC-DC step-up converter circuit of claim 6 wherein first DC-DC boost converter further comprises:
a resistor coupled to said first switch; and
a photodiode coupled to said resistor.

8. The DC-DC step-up converter circuit of claim 3 wherein said a second DC-DC boost converter stage comprises:
a second inductor having a first terminal coupled to said input voltage Vin;
a second electrical fuse coupled to a second terminal of said second inductor;
a second switch coupled to said electrical fuse, wherein said second switch is driven by a second signal of said input voltage Vin;
a capacitor coupled to the second terminal of said second inductor;
a second diode coupled in parallel to said capacitor; and
a first diode coupled in series to said capacitor and the anode of said second diode.

9. The DC-DC step-up converter circuit of claim 8 wherein said second switch is selected from a semiconductor device consisting of MOSFET (Metal-Oxide-Semiconductor Field-Effect Transistor); JFET (Junction Field-Effect Transistor); MESFET (Metal-Semiconductor Field-Effect Transistor); IGBT (Insulated Gate Bipolar Transistor).

10. The DC-DC step-up converter circuit of claim 9, wherein said second DC-DC boost converter stage further comprises:
a second resistor coupled to said second switch; and
a second photo diode coupled to said second resistor.

11. The DC-DC step-up converter circuit of claim 10 wherein said a third DC-DC boost converter stage comprises:
a third inductor having a first terminal coupled to said input voltage Vin;
a third electrical fuse coupled to a second terminal of third second inductor;
a third switch coupled to said electrical fuse, wherein said third switch is driven by a third signal of said input voltage Vin;
a capacitor coupled to the second terminal of said third inductor;
a second directional diode coupled in parallel to said capacitor; and
a first directional diode coupled in series to said capacitor and the anode of said second directional diode.

12. The DC-DC step-up converter circuit of claim 11 wherein said second switch is selected from a semiconductor device consisting of MOSFET (Metal-Oxide-Semiconductor Field-Effect Transistor); JFET (Junction Field-Effect Transistor); MESFET (Metal-Semiconductor Field-Effect Transistor); IGBT (Insulated Gate Bipolar Transistor).

13. The DC-DC step-up converter circuit of claim 12, wherein said third DC-DC boost converter stage further comprises:
a third resistor coupled to said third switch; and
a third diode coupled to said third resistor.

14. The DC-DC step-up converter circuit of claim 13 wherein a fourth DC-DC boost converter stage comprises:
a fourth inductor having a first terminal coupled to said input voltage Vin;
a fourth electrical fuse coupled to a second terminal of said fourth inductor;
a fourth switch coupled to said electrical fuse, wherein said fourth switch is driven by a fourth signal of said input voltage Vin;
a capacitor coupled to the second terminal of said fourth inductor;
a second directional diode coupled in parallel to said capacitor; and
a first directional diode coupled in series to said capacitor and the anode of said second directional diode.

15. The DC-DC step-up converter circuit of claim 14 wherein said fourth switch is selected from a semiconductor device consisting of MOSFET (Metal-Oxide-Semiconductor Field-Effect Transistor); JFET (Junction Field-Effect Transistor); MESFET (Metal-Semiconductor Field-Effect Transistor); IGBT (Insulated Gate Bipolar Transistor).

16. The DC-DC step-up converter circuit of claim 14, wherein said second DC-DC boost converter stage further comprises:
a fourth resistor coupled to said fourth switch; and
a fourth photodiode coupled to said fourth resistor.

17. A method for generating a constant DC voltage, comprising:
forming a plurality of DC-DC step-up stages, wherein each of said DC-DC step-up stages outputs an output voltage equals to
$$\frac{Vin}{1 - D}$$
where D is a duty cycle of an input voltage Vin;
connecting said plurality of DC-DC step-up stages in parallel wherein said plurality of DC-DC step-up stages have a common input node coupled to said input voltage Vin; and
driving said plurality of DC-DC step-up stages by said input voltage Vin that any consecutive step-up stages are driven 180° out of phase, and wherein said constant DC voltage equals to
$$\frac{NVin}{1 - D}$$
wherein N is the number of DC-DC step-up stages.

18. The method of claim 17 further comprising setting said duty cycle D is between 0.5≤D≤1.0.

19. The method of claim 18 further comprising comparing an output voltage Vₒᵤₜ and a reference voltage V_{ref}, wherein if said output voltage Vₒᵤₜ equals to said reference voltage V_{ref} then maintain said duty cycle D.

20. The method of claim 19 wherein when said output voltage Vₒᵤₜ IS different from said reference voltage V_{ref} by an amount
$$\frac{Δ V}{{V}_{ref}} > 0.1$$
then adjusting said duty cycle by an amount of ΔD, wherein
$$Δ D = {k}_{p} e ( t ) + {k}_{i} {\int }_{0}^{t} e ( t ) dt ,$$
wherein e(t) is an error signal proportional to e(t)=|V_{ref}−Vₒᵤₜ|, and wherein kₚ is a preselected constant.
